(19) United States
(12) Patent Application Publication
(10) Pub. No.: US 2021/0033071 A1
(43) Pub. Date: Feb. 4, 2021

(54) WIND-DRIVEN POWER GENERATION DEVICE BASED ON MAGNETIC LEVITATION

(71) Applicant: Yun-Lai LIU, New Taipei City (TW)

(72) Inventor: Yun-Lai LIU, New Taipei City (TW)

(21) Appl. No.: 16/867,991

(22) Filed: May 6, 2020

(30) Foreign Application Priority Data
Aug. 1, 2019 (TW) 108210151

(51) Int. Cl. F03D 13/20; F03D 3/00; F03D 80/80; F03D 9/25; H02N 15/00

(52) U.S. Cl. CPC F03D 13/20; F03D 3/005; F03D 3/065; F03D 9/25; H02N 15/00; F03D 80/82

(57) ABSTRACT

A wind-driven power generation device based on magnetic levitation is provided. The device includes a magnetic levitation structure, a wind fan, a driving fan, and an electric power generator. Since a floating magnet floated above a fixed magnet in the magnetic levitation structure, the rotation friction of the fan shaft of the wind fan can be greatly reduced to stabilize the output electric power of the wind-driven power generation device.

### FIELD OF TECHNOLOGY

This invention relates to a wind-driven power generation device, particularly to a wind-driven power generation device based on magnetic levitation.

### BACKGROUND

A type of conventional wind-driven power generation device mainly includes a wind fan including a fan shaft and a plurality of blades fixed on the fan shaft, and an electric power generator having a mandrel connected to the fan shaft of the wind fan. When the wind flows through the wind fan, the wind fan begins to rotate, and thus the mandrel of the electric power generator is driven to rotate to generates electric power.

However, in the conventional wind-driven power generation device, the lower end of the fan shaft of the wind fan is rotatably installed at a fixed end. The rotational friction is thus quite large, and a relatively strong wind is required to drive the blades to rotate the fan shaft and thus the electric power generator to generate electric power. If the wind is weak, the electric power generated by the electric power generator is quite weak. Hence, the overall power generation efficiency is rather low, making utilization value quite low.

### SUMMARY

In light of the forgoing, a wind-driven power generation device based on magnetic levitation is provided to solve the shortcomings in the prior art.

In an aspect of this invention, a wind-driven power generating device based on magnetic levitation is proposed. The magnetic levitation structure is provided below a wind fan and an electric power generator, so the overall rotation resistance is very small. Only tiny power is needed to start the electric power generator. In addition, a driving fan is further provided for driving the wind fan. Hence, the stability of the entire system can be maintained, and the amount of the generated electric power can also be maintained at a certain level without much affected by external wind.

In order to achieve the above aspect, a wind-driven power generating device based on magnetic levitation is provided. The wind-driven power generating device comprises a magnetic levitation structure, a wind fan, a driving fan, and an electric power generator. The magnetic levitation structure comprises a magnet holder, a fixed magnet fixed on the magnet holder, and a floating magnet disposed above the fixed magnet. The same magnetic pole of the fixed magnet and the floating magnet are opposite to each other so that the floating magnet can float above the fixed magnet. The wind fan comprises a fan shaft and a plurality of blades fixed on the fan shaft, and a lower end of the fan shaft is rotatably coupled to the floating magnet. The driving fan comprises a power supply for providing electric power thereto for driving the driving fan. The driving fan is disposed on a side of the wind fan, so that the blades of the wind fan are driven when the driving fan generates wind. The electric power generator comprises a mandrel. The mandrel is connected to an upper end of the fan shaft of the wind fan, so that the mandrel is driven by rotating the wind fan and thus the electric power generator generates electric power.

Another wind-driven power generating device based on magnetic levitation is also provided. The wind-driven power generating device comprises a magnetic levitation structure, an electric power generator, a wind fan, and a driving fan. The magnetic levitation structure comprises a magnet holder, a fixed magnet fixed on the magnet holder, and a floating magnet disposed above the fixed magnet. The same magnetic pole of the fixed magnet and the floating magnet are opposite to each other so that the floating magnet can float above the fixed magnet. The electric power generator comprises a mandrel, and a lower end of the mandrel is rotatably coupled to the floating magnet. The wind fan comprises a fan shaft and a plurality of blades fixed on the fan shaft. The fan shaft is connected to an upper end of the mandrel. When the fan shaft rotates, the mandrel of the electric power generator is driven to rotate to generate electric power. The driving fan comprises a power supply for providing electric power thereto for driving the driving fan, wherein the driving fan is disposed on a side of the wind fan, so that the blades of the wind fan are driven when the driving fan generates wind.

In some embodiments, the electric power generator further comprises a central rotor, a plurality of outer magnets disposed around the central rotor, and a plurality of electric generation coils arranged on the periphery of the central rotor. The magnetic poles of the outer magnets are staggered with each other. The central axis of the electric generation coils each faces the axis of the central rotor, and the staggering magnetic poles of the outer magnets respectively penetrates the electric generation coils to induce the electric generation coils for generating electric power.

In some other embodiments, the device further comprises a conductive wire for transporting the electric power generated by one of the electric generation coils to the power supply.

In yet some other embodiments, the device further comprises a detector and a controller. The detector is installed on the wind fan for detecting the rotation speed of the wind fan to obtain a detection result of the rotation speed. The controller receives the detection result to adjust the electric power output of the power supply according to the detection result for controlling the rotation speed of the wind fan to stabilize the electric power output of the electric power generator at a required level.

In still some other embodiments, the magnet holder moves up and down relative to the floating magnet to change a distance between the fixed magnet and the floating magnet.

In still some other embodiments, the device further comprises a lubrication groove disposed on the fan shaft and the mandrel of the electric power generator for inputting lubricating oil into the lubricating groove, so that the fan shaft and the mandrel of the electric power generator are rotated more smoothly.

The features and advantages of this invention can be further understood from the following description. Please refer to the drawings when reading.

### BRIEF DESCRIPTION OF THE DRAWINGS

FIG. 1 is a schematic perspective view showing a combination of the main components of a wind-driven power generating device based on magnetic levitation according to some embodiments of this invention.

FIG. 2 is another schematic perspective view showing the wind-driven power generating device based on magnetic levitation in FIG. 1.

FIG. 3 is a three-dimensional schematic view showing a combination of components of a wind-driven power generating device based on magnetic levitation in FIG. 1.

FIG. 4 is a cross-sectional side view showing a combination of components of a wind-driven power generating device based on magnetic levitation in FIG. 1.

FIG. 5 is a cross-sectional side view showing a combination of components of a wind-driven power generating device based on magnetic levitation according to some other embodiments of this invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

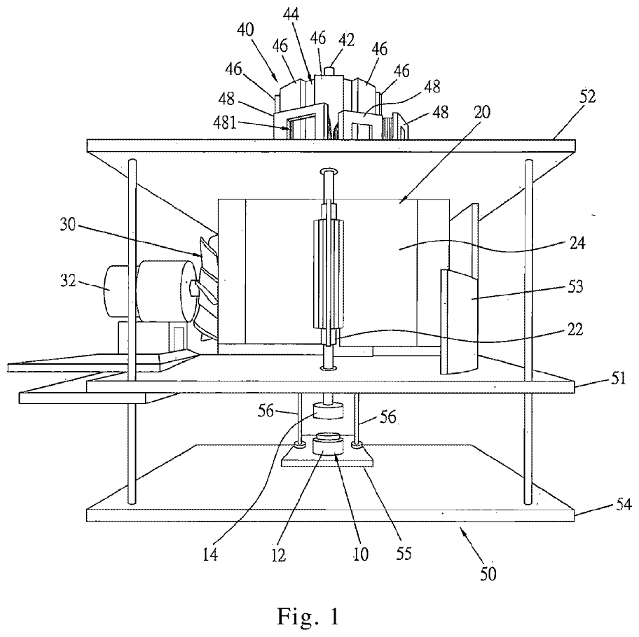

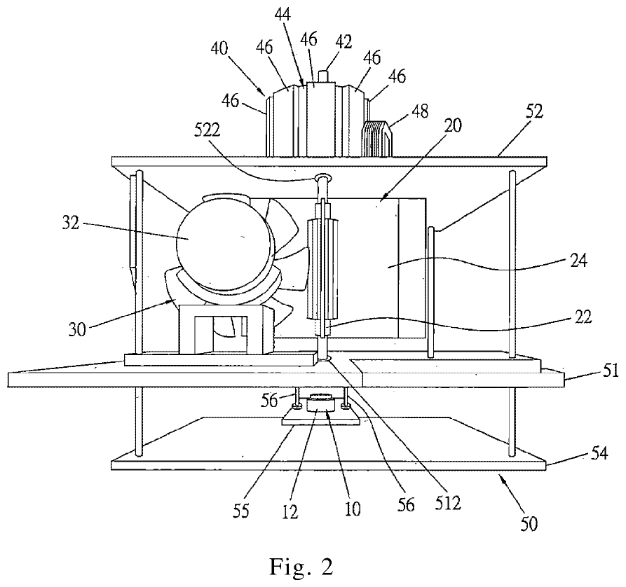

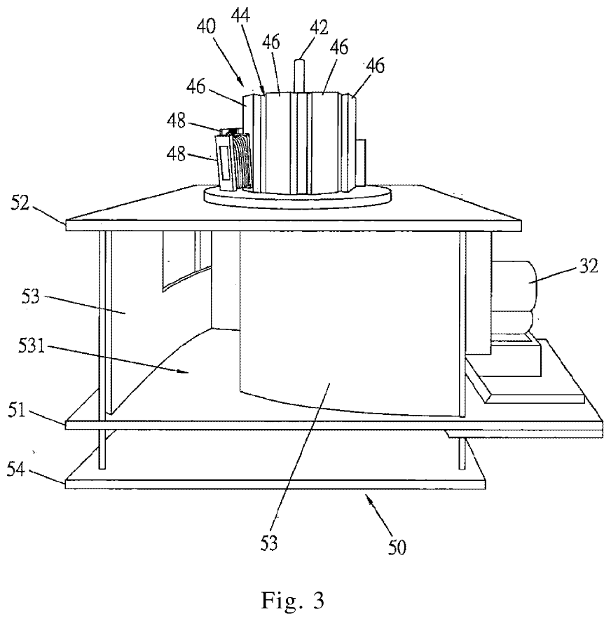

FIGS. 1-4 show a wind-driven power generation device based on magnetic levitation according to some embodiments of this invention. In FIGS. 1-4, the wind-driven power generation device comprises a magnetic levitation structure 10, a wind fan 20, a driving fan 30, and an electric power generator 40, basically from bottom to top. The magnetic levitation structure 10 comprises a magnet holder 55, a fixed magnet 12 fixed on the magnet holder 55, and a floating magnet 14 disposed above the fixed magnet 12. The same magnetic pole of the fixed magnet 12 and the floating magnet 14 are opposite to each other so that the floating magnet 14 can float above the fixed magnet 12. In some embodiments, the magnet holder 55 can move up and down relative to the floating magnet 14 to change the distance between the fixed magnet 12 and the floating magnet 14.

The wind fan 20 comprises a fan shaft 22 and a plurality of blades 24 fixed on the fan shaft 22. The lower end of the fan shaft 22 is rotatably coupled to the upper side of the floating magnet 14.

The driving fan 30 is disposed on a side of the wind fan 20. Therefore, the blades 24 of the wind fan 20 can be driven to rotate when the driving fan 30 rotates to generate wind blowing on the blades 24 of the wind fan 20. In addition, the wind fan 20 can be also rotated when external wind blows on the blades 24 of the wind fan 20. In some other embodiments, the driving fan 30 electrically connects to a power supply 32. The power supply 32 can provide electric power for driving the driving fan 30. The power supply 32 may be a battery combination, for example.

The electric power generator 40 comprises a mandrel 42. The mandrel 42 is connected to the upper end of the fan shaft 22 of the wind fan 20. Hence, the mandrel 42 is driven by rotating the wind fan 20 and thus the electric power generator 40 generates electric power.

In some other embodiments, the electric power generator 40 further comprises a central rotor 44, a plurality of outer magnets 46 disposed around the central rotor 44, and a plurality of electric generation coils 48 arranged on the periphery of the central rotor 44. The magnetic poles of the outer magnets 46 are staggered with each other. The central axis of the electric generation coils 48 each faces the axis of the central rotor 44, and the staggering magnetic poles of the outer magnets 46 can respectively penetrate the electric generation coils 48. Therefore, when the central rotor 44 rotates, the staggering magnetic poles of the outer magnets 46 can quickly scan the electric generation coils 48. Hence, the electric generation coils 48 are induced by the variation of the magnetic field to generate electric current.

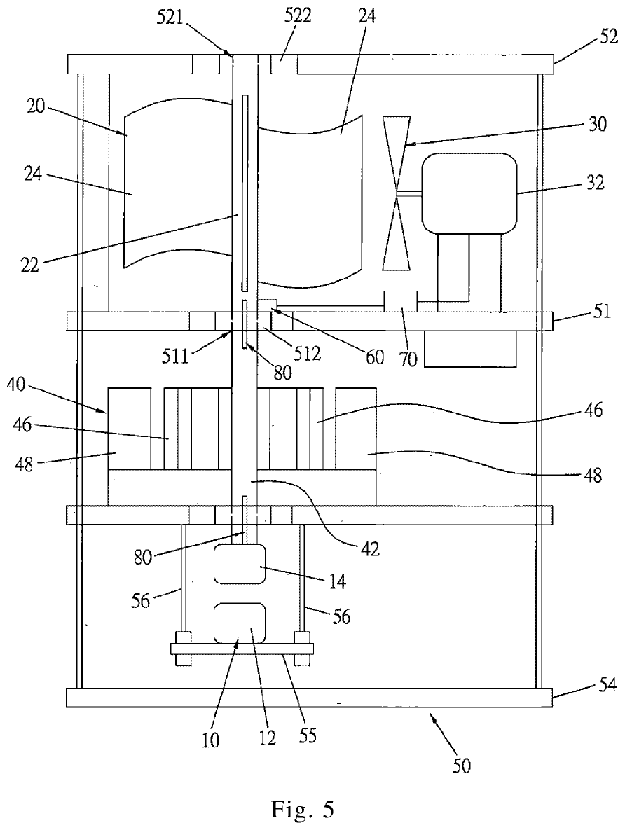

FIG. 5 is a cross-sectional side view showing a combination of components of a wind-driven power generating device based on magnetic levitation according to some other embodiments of this invention. In FIG. 5, the wind-driven power generating device comprises a magnetic levitation structure 10, an electric power generator 40, a wind fan 20, and a driving fan30, basically from bottom to top. The magnetic levitation structure 10 comprises a magnet holder 55, a fixed magnet 12 fixed on the magnet holder 55, and a floating magnet 14 disposed above the fixed magnet 12. The same magnetic pole of the fixed magnet 12 and the floating magnet 14 are opposite to each other so that the floating magnet 14 can float above the fixed magnet 12. In some embodiments, the magnet holder 55 can move up and down relative to the floating magnet 14 to change the distance between the fixed magnet 12 and the floating magnet 14.

The electric power generator 40 comprises a mandrel 42. The lower end of the mandrel 42 is rotatably coupled to the floating magnet 14.

The wind fan 20 comprises a fan shaft 22 and a plurality of blades 24 fixed on the fan shaft 22. The fan shaft 22 is connected to the upper end of the mandrel 42. When the fan shaft 22 rotates, the mandrel 42 of the electric power generator 40 is driven to rotate to generate electric power.

The driving fan 30 is disposed on a side of the wind fan 20. Therefore, the blades 24 of the wind fan 20 can be driven to rotate when the driving fan 30 rotates to generate wind blowing on the blades 24 of the wind fan 20. In addition, the wind fan 20 can be also rotated when external wind blows on the blades 24 of the wind fan 20. In some other embodiments, the driving fan 30 electrically connects to a power supply 32. The power supply 32 can provide electric power for driving the driving fan 30. The power supply 32 may be a battery combination, for example.

Referring to FIGS. 1-4 again, in some other embodiments, the device further comprises a fixed frame 50. The fixed frame 50 comprises a base 54, a first platform 51, and a second platform 52, from bottom to top. The first platform 51 comprising a first perforation 511 therein and a first bearing 512. The first perforation 511 allows the lower end of the fan shaft 22 to be passed through. The first bearing 512 is installed on the lower end of the fan shaft 22 and in the first perforation 511, so that the lower end of the fan shaft 22 may be rotated smoothly in the first perforation 511.

The base 54 is disposed below and connect to the first platform 51 for supporting the first platform 51. The magnet holder 55 may be disposed between the base 54 and the first platform 51. The magnet holder 55 is connected below the first platform 51 through at least one rod 56. Hence, the magnet holder 55 can move up and down along the at least one rod 56 to change a distance between the fixed magnet 12 and the floating magnet 14.

The second platform 52 comprising a second perforation 521 therein and a second bearing 522. The second perforation 521 allows the upper end of the fan shaft 22 to be passed through. The second bearing 522 is installed on the lower end of the fan shaft 22 and in the second perforation 521, so that the lower end of the fan shaft 22 may be rotated smoothly in the second perforation 521.

In yet some other embodiments, the fixed frame 50 may further comprises a wind scooper 53 having a wind inlet 531. The wind scooper 53 is disposed at a side of the wind fan 20 and between the first platform 51 and the second platform 52. The wind scooper 53 covers only a part of the side of the wind fan 20 to leave the wind inlet 531. Thus, the blades 24 can be driven by external wind that enters the wind inlet 531 and passes through the wind scooper 53 to blow on the blades 24 to rotate the wind fan 20.

In yet some other embodiments, another wind scooper 53 may further disposed on another side of the wind fan 20, depending on the actual need.

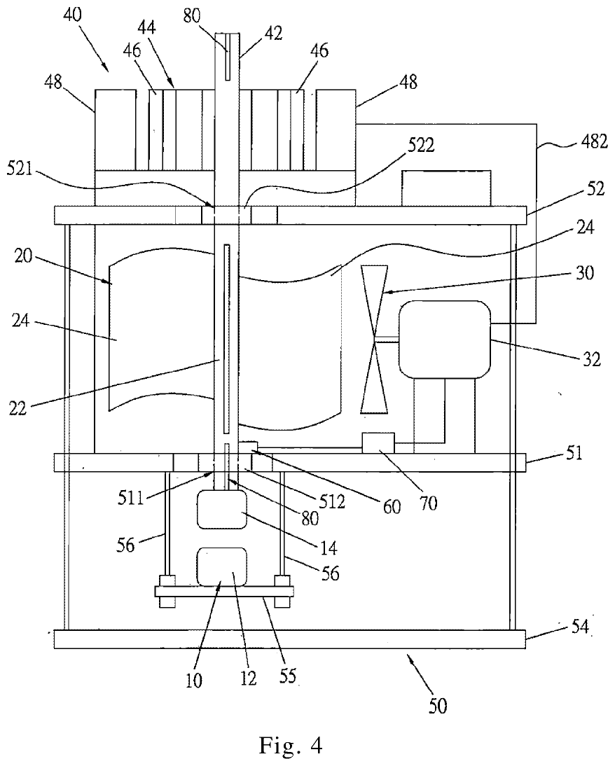

In still some other embodiments, the device further comprises a lubrication groove 80 disposed on the fan shaft 22 of the wind fan 20 and the mandrel 42 of the electric power generator 40 (FIGS. 4-5). Therefore, lubricating oil may be input into the lubricating groove 80 to make the fan shaft 22 and the mandrel 42 rotate more smoothly.

In some other embodiments, the device further comprises a conductive wire 482 (FIG. 4) for transporting the electric power generated by one of the electric generation coils 48 to the power supply 32. Therefore, the driving fan 30 may be driven without using external electricity.

In FIGS. 4-5, the device further comprises a detector 60 and a controller 70. The detector 60 is installed on the wind fan 20 for detecting the rotation speed of the wind fan 20 to obtain a detection result of the rotation speed. The controller 70 receives the detection result to adjust the electric power output of the power supply 32 according to the detection result for controlling the rotation speed of the wind fan 20 to stabilize the electric power output of the electric power generator 40 at a required level. The detector 60 and the controller 70 shown in FIGS. 4-5 are only schematic diagrams.

When this device is used, the wind-driven power generation device can be placed on a wind receiving surface, and the wind fan can be driven by external wind to drive the electric power generator for generating electric power. According to some embodiments, the wind power electric power generator may be installed on a wind receiving surface in front of a vehicle. When the vehicle travels, the windward side of the vehicle will receive a quite amount of wind, which is enough to drive the wind fan 20. Hence, the electric power generator can generate a quite amount of electric power. This electric power can be supplied to automotive systems to achieve energy saving and carbon reduction.

In some embodiments, the lower end of this wind-driven power generating device uses a magnetic levitation structure to make the wind fan and the electric power generator float above, so the overall rotation resistance is very small, and only tiny power is needed to start the electric power generator. In addition, the wind fan is driven by the driving fan, so the stability of the entire system can be maintained, and the amount of generated electric power can have a certain value and will not be completely affected by external wind.

In summary, the humane and considerate design provided above is quite in accordance with the actual needs. Compared with the conventional technology, this device provided in this disclosure improves the existing shortcomings and has obvious outstanding advantages over conventional technologies, which has an improvement in efficacy and is not easy to achieve. It will be apparent to those skilled in the art that various modifications and variations can be made to the structure of the present invention without departing from the scope of the invention. In view of the foregoing, it is intended that the present invention cover modifications and variations of this invention provided they fall within the scope of the following claims.

What is claimed is:

1. A wind-driven power generating device based on magnetic levitation, the device comprising:
a magnetic levitation structure, comprising:
a magnet holder;
a fixed magnet fixed on the magnet holder; and
a floating magnet disposed above the fixed magnet, wherein same magnetic pole of the fixed magnet and the floating magnet are opposite to each other so that the floating magnet floats above the fixed magnet;
a wind fan comprising a fan shaft and a plurality of blades fixed on the fan shaft, wherein a lower end of the fan shaft is rotatably coupled to the floating magnet;
a driving fan comprising a power supply for providing electric power thereto for driving the driving fan, wherein the driving fan is disposed on a side of the wind fan, so that the blades of the wind fan are driven when the driving fan generates wind; and
an electric power generator comprising a mandrel, wherein the mandrel is connected to an upper end of the fan shaft of the wind fan, so that the mandrel is driven by rotating the wind fan and thus the electric power generator generates electric power.

2. The device of claim 1, wherein the electric power generator further comprises:
a central rotor;
a plurality of outer magnets disposed around the central rotor, wherein the magnetic poles of the outer magnets are staggered with each other; and
a plurality of electric generation coils arranged on the periphery of the central rotor, wherein a central axis of the electric generation coils each faces an axis of the central rotor, and the staggering magnetic poles of the outer magnets respectively penetrates the electric generation coils to induce the electric generation coils for generating electric power.

3. The device of claim 1, further comprising a fixed frame comprising:
a first platform comprising a first perforation therein, wherein the first perforation allows a lower end of the fan shaft to be passed through;
a first bearing installed on the lower end of the fan shaft and in the first perforation, so that the lower end of the fan shaft is rotated smoothly in the first perforation;
a base disposed below and connect to the first platform for supporting the first platform, wherein the magnet holder is disposed between the base and the first platform;
a second platform comprising a second perforation therein, the second perforation allows an upper end of the fan shaft to be passed through;
a second bearing installed on the upper end of the fan shaft and in the second perforation, so that the upper end of the fan shaft is rotated smoothly in the second perforation;
a wind scooper disposed at a side of the wind fan and between the first platform and the second platform, wherein the wind scooper covers only a part of the side of the wind fan to leave a wind inlet, and the blades are driven by wind that enters the wind inlet and passes through the wind scooper to blow on the blades to rotate the wind fan.

4. The device of claim 3, further comprising another wind scooper disposed on a different side of the wind fan.

5. The device of claim 1, further comprising a conductive wire for transporting the electric power generated by one of the electric generation coils to the power supply.

6. The device of claim 1, further comprising:
a detector installed on the wind fan for detecting the rotation speed of the wind fan to obtain a detection result of the rotation speed; and
a controller receiving the detection result to adjust the electric power output of the power supply according to the detection result for controlling the rotation speed of the wind fan to stabilize the electric power output of the electric power generator at a required level.

7. The device of claim 1, wherein the magnet holder moves up and down relative to the floating magnet to change a distance between the fixed magnet and the floating magnet.

8. The device of claim 7, wherein the magnet holder is connected below the first platform through at least one rod, and the magnet holder moves up and down along the at least one rod.

9. The device of claim 1, further comprising a lubrication groove disposed on the fan shaft and the mandrel of the electric power generator for inputting lubricating oil into the lubricating groove, so that the fan shaft and the mandrel of the electric power generator are rotated more smoothly.

10. A wind-driven power generating device based on magnetic levitation, the device comprising:
a magnetic levitation structure, comprising:
a magnet holder;
a fixed magnet fixed on the magnet holder; and
a floating magnet disposed above the fixed magnet, wherein same magnetic pole of the fixed magnet and the floating magnet are opposite to each other so that the floating magnet floats above the fixed magnet;
an electric power generator comprising a mandrel, wherein a lower end of the mandrel is rotatably coupled to the floating magnet;
a wind fan comprising a fan shaft and a plurality of blades fixed on the fan shaft, wherein the fan shaft is connected to an upper end of the mandrel, and when the fan shaft rotates, the mandrel of the electric power generator is driven to rotate to generate electric power; and
a driving fan comprising a power supply for providing electric power thereto for driving the driving fan, wherein the driving fan is disposed on a side of the wind fan, so that the blades of the wind fan are driven when the driving fan generates wind.

11. The device of claim 10, wherein the electric power generator further comprises:
a central rotor;
a plurality of outer magnets disposed around the central rotor, wherein the magnetic poles of the outer magnets are staggered with each other; and
a plurality of electric generation coils arranged on the periphery of the central rotor, wherein a central axis of the electric generation coils each faces the axis of the central rotor, the staggering magnetic poles of the outer magnets each penetrates the electric generation coils each to induce the electric generation coils and thus the electric power generator generates electric power.

12. The device of claim 10, further comprising a conductive wire for transporting the electric power generated by one of the electric generation coils to the power supply.

13. The device of claim 10, further comprising:
a detector installed on the wind fan for detecting the rotation speed of the wind fan to obtain a detection result of the rotation speed; and
a controller receiving the detection result to adjust the electric power output of the power supply according to the detection result for controlling the rotation speed of the wind fan to stabilize the electric power output of the electric power generator at a required level.

14. The device of claim 10, wherein the magnet holder moves up and down relative to the floating magnet to change a distance between the fixed magnet and the floating magnet.

15. The device of claim 10, further comprising a lubrication groove disposed on the fan shaft and the mandrel of the electric power generator for inputting lubricating oil into the lubricating groove, so that the fan shaft and the mandrel of the electric power generator are rotated more smoothly.
